(19) United States
(12) Patent Application Publication
(10) Pub. No.: US 2006/0012771 A1
(43) Pub. Date: Jan. 19, 2006

(54) System and method for manufacturing a flat panel display

(75) Inventor: Sang-Ki Jeong, Cheonan-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/179,086

(22) Filed: Jul. 11, 2005

(30) Foreign Application Priority Data
Jul. 19, 2004 (KR) 10-2004-0055986

(51) Int. Cl. G03B 27/62

(52) U.S. Cl. 355/75

(57) ABSTRACT

A system for manufacturing a flat panel display is provided including: a first mask loading/unloading part for loading at least one mask; a main mask-stage for disposing the mask; a first mask-transferer for transferring the mask from the first mask loading/unloading part onto the main mask-stage; a second mask loading/unloading part positioned apart from the first mask loading/unloading part by a predetermined distance; and a second mask-transferer for transferring the mask from the second mask loading/unloading part onto the main mask-stage. This system may reduce the time required for changing masks used to manufacture flat panel displays.

### BACKGROUND

(a) Field of the Invention

The present invention relates to a system and method for manufacturing a flat panel display, and in particular, to an exposure system and method for forming a semiconductor layer on a substrate.

(b) Description of Related Art

Flat panel displays, such as liquid crystal displays (LCDs) and organic light emitting diode (OLED) displays, are widely used. A liquid crystal display includes a pair of panels, which include field generating electrodes formed thereon, and a liquid crystal layer disposed therebetween. Liquid crystal molecules of the liquid crystal layer are rearranged by voltages supplied to the electrodes. Transmittance of light passing through the liquid crystal layer is controlled by the rearrangement of the liquid crystal layer.

Such a panel is manufactured by sequentially processing the substrate with, for example, a thin film deposition process, a cleaning process, a resist coating process, an exposure process, and an etching process.

An exposure system for performing the exposure process includes a mask, a mask-loader for loading the mask, a mask stage, a mask-transferer for transferring the mask from the mask-loader onto the mask stage, and a substrate transferee. Only one mask-loader, one mask stage, and one mask-transferer are provided in the exposure system.

In the event that the mask is contaminated or a model is changed, the mask may need to be changed.

Conventional exposure systems may experience a variety of problems. For example, since only one mask-loader, one mask stage, and one mask-transferer are provided in the exposure system, an excessive amount of time may be consumed in changing the mask, when a change of mask is required. In particular, when the mask is changed, a new mask is transferred from the mask-loader to the mask stage, only after the original mask is completely transferred from the mask stage to the mask-loader by the mask-transferer. Accordingly, an excessive amount of time may be consumed by the change of mask.

Consequently, during manufacture of the liquid crystal display, manufacturing time may be wasted. For example, 5 to 10 minutes may be consumed by a cycle for merely changing the mask. As a result, productivity may deteriorate.

### SUMMARY

A method and apparatus for manufacturing a flat panel display which may resolve the above-mentioned problems and significantly decrease the mask-change time are provided.

An exemplary system for manufacturing a flat panel display according to an embodiment of the present invention includes: a first mask loading/unloading part for loading or unloading at least one mask; a main mask-stage for receiving the mask; a first mask-transferer for transferring the mask from the first mask loading/unloading part onto the main mask-stage; a second mask loading/unloading part positioned apart from the first mask loading/unloading part by a predetermined distance; and a second mask-transferer for transferring the mask from the second mask loading/unloading part onto the main mask-stage.

In a further embodiment according to the present invention, the system further includes: a first assistant mask-stage positioned between the main mask-stage and the first mask loading/unloading part; and a second assistant mask-stage positioned between the main mask-stage and the second mask loading/unloading part.

In another further embodiment according to the present invention, the system further includes: a shuttle or a Linear Motion (LM) guider respectively positioned between the main mask-stage and the first assistant mask-stage, and between the main mask-stage and the second assistant mask-stage.

In another further embodiment according to the present invention, the system further includes: a substrate fixer positioned below the main mask-stage and apart therefrom by a predetermined distance; a plurality of substrate loading/unloading parts for loading or unloading the substrate; and a substrate-transferer for transferring a substrate from a selected substrate loading/unloading part of the substrate loading/unloading parts onto the substrate fixer or transferring the substrate from the substrate fixer onto the selected substrate loading/unloading part.

In another further embodiment according to the present invention, the system further includes: first and second substrate fixers respectively positioned below the first and second assistant mask-stages and apart therefrom by a predetermined distance; first and second substrate loading/unloading parts for loading or unloading the substrate; and first and second substrate-transferers for respectively transferring a substrate from the first and the second substrate loading/unloading parts onto the first and the second substrate fixers or respectively transferring the substrate from the first and the second substrate fixers onto the first and the second substrate loading/unloading parts.

In another further embodiment according to the present invention, the first and second substrate fixers move horizontally.

An exemplary method for manufacturing a flat panel display according to an embodiment of the present invention includes; transferring a first mask from a first mask loading/unloading part onto a main mask-stage by a first mask-transferer; transferring a second mask from a second mask loading/unloading part onto a second assistant mask-stage by a second mask-transferer; performing an exposure process for a predetermined time by the first mask on the main mask-stage; transferring the first mask from the main mask-stage onto the first assistant mask-stage, and transferring a second mask from the second assistant mask-stage onto the main mask-stage, after completing the exposure process for the predetermined time; and performing an exposure process using the second mask on the main mask-stage for a predetermined time.

In a further embodiment according to the present invention, the first mask and second masks have a same pattern.

In another further embodiment according to the present invention, the method further includes: transferring the first mask from the first assistant mask-stage onto the first mask loading/unloading part by the first mask-transferer; transferring a third mask from the first mask loading/unloading part onto the first assistant mask-stage by the first mask-transferer; transferring the second mask from the main mask-stage onto the second assistant mask-stage, and transferring the third mask from the first assistant mask-stage onto the main mask-stage, after completing the exposure process for the predetermined time by the second mask; and performing an exposure process using the third mask on the main mask-stage for a predetermined time.

In another further embodiment according to the present invention, the exposure process includes: transferring a substrate from a selected substrate loading/unloading part of the substrate loading/unloading parts onto a substrate fixer by a substrate-transferer; exposing the substrate by the first mask of the main mask-stage; and transferring the exposed substrate from the substrate fixer onto the selected substrate loading/unloading part.

In another further embodiment according to the present invention, the exposure process includes: transferring a substrate from a first substrate loading/unloading part onto a first substrate fixer, positioned to a lower side of the fist assistant mask-stage, by a substrate-transferer; moving the first substrate fixer such that the substrate is positioned to a lower side of the main mask-stage; exposing the substrate by the first mask of the main mask-stage; and transferring the exposed substrate from the first substrate fixer onto the first substrate loading/unloading part.

### BRIEF DESCRIPTION OF THE DRAWINGS

The present invention will become more apparent by describing preferred embodiments thereof in detail with reference to the accompanying drawings, in which:

FIGS. 1 to 4 are top plan views of an exposure system according to an embodiment of the present invention, and show sequential operations in which a mask and a substrate are transferred; and

FIGS. 5 to 8 are top plan views of an exposure system according to another embodiment of the present invention, and show sequential operations in which a mask and a substrate are transferred.

### DETAILED DESCRIPTION

The present invention will be described more fully hereinafter with reference to the accompanying drawings, in which preferred embodiments of the inventions are shown. This invention may, however, be embodied in many different forms and should not be construed as limited to the embodiments set forth herein.

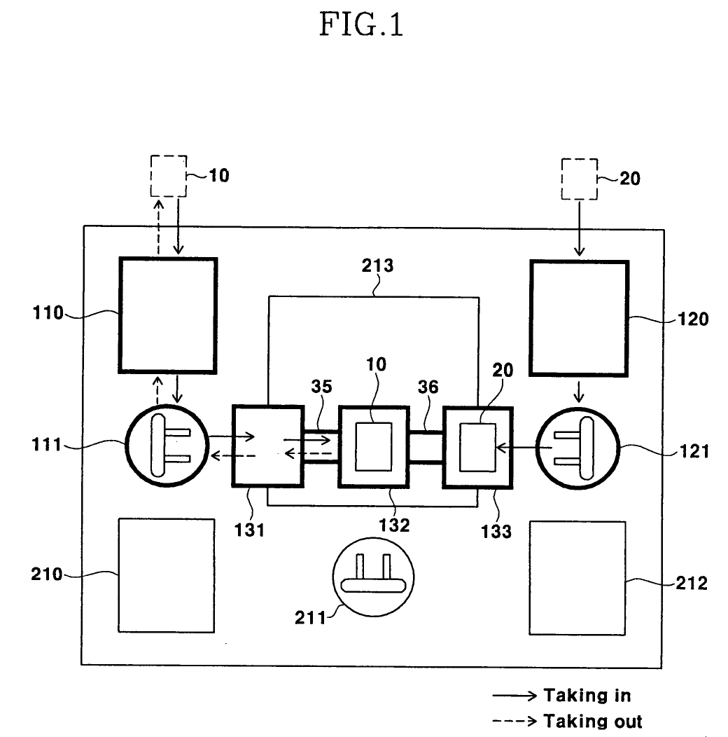

A system for manufacturing a flat panel display according to an embodiment of the present invention will hereinafter be described in detail with reference to FIGS. 1 to 4.

FIGS. 1 to 4 are top plan views of an exposure system according to an embodiment of the present invention, and show sequential operations in which a mask and a substrate are transferred.

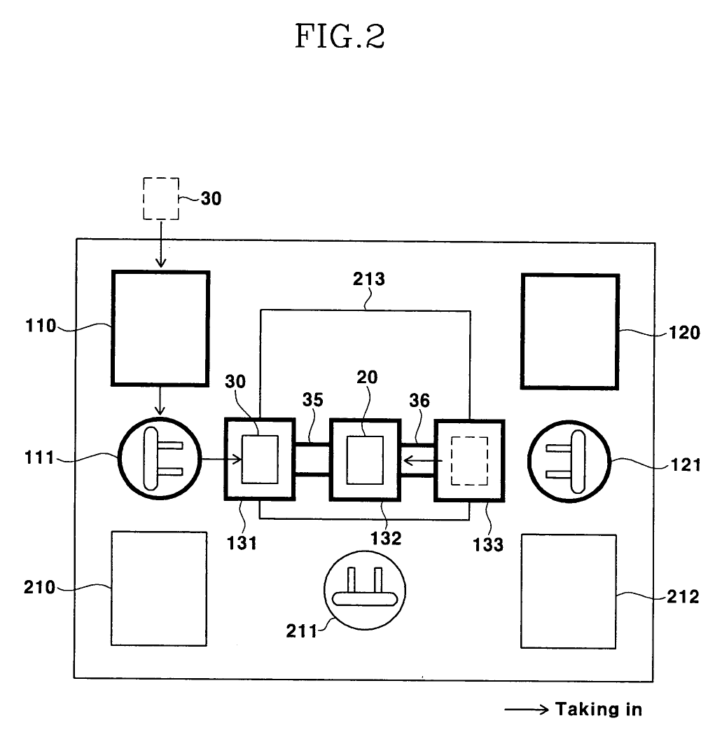

As shown in FIGS. 1 and 2, an exposure system according to an embodiment of the present invention includes a first mask loading/unloading part 110, a first mask-transferer 111, a first assistant mask-stage 131, a main mask-stage 132, a second assistant mask-stage 133, a second mask-transferer 121, and a second mask loading/unloading part 120. Such devices 110, 111, 131, 132, 133, 121, and 120 for a mask are arranged in a generally “U”-shaped pattern.

The exposure system according to an embodiment of the present invention further includes a substrate fixer 213, a substrate-transferer 211, a first substrate loading/unloading part 212, and a second substrate loading/unloading part 210. Such devices for a substrate are positioned apart from the above-mentioned mask-handling devices by a predetermined distance, and are positioned to a lower side of the mask-handling devices.

The first and second mask loading/unloading parts 110 and 120 are respectively loaded with at least one mask, and the first mask loading/unloading part 110 is positioned apart from the second mask loading/unloading part 120 by a predetermined distance.

The first mask-transferer 111 transfers a first mask 10 from the first mask loading/unloading part 110 onto the first assistant mask-stage 131 (or directly onto the main mask-stage 132 if a mask is not already present).

The second mask-transferer 121 transfers a second mask 20 from the second mask loading/unloading part 120 onto the second assistant mask-stage 133 (or the main mask-stage 132).

It is preferable that the first and second masks 10 and 20 have the same pattern as each other. In other embodiments, the first and second masks may have different patterns.

The first and the second mask-transferers 111 and 121 may comprise robot arms which can move and rotate the mask vertically and/or horizontally.

As mentioned above, since multiple mask-loaders and mask-transferers are provided, the unloading of the current mask and the loading of a replacement mask can be performed in parallel. Thus, a mask-change time (i.e., time consumed for changing a mask) can be decreased.

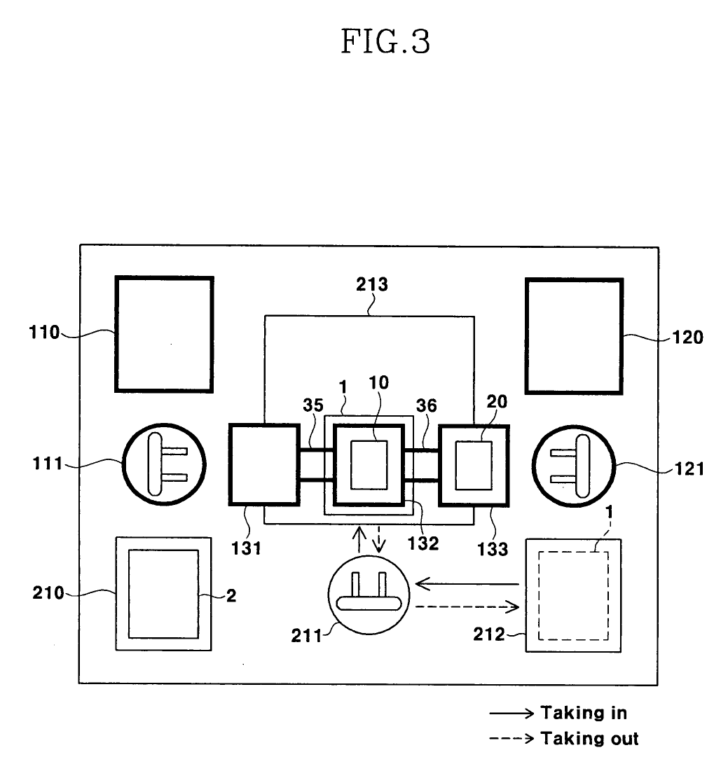

The mask 10 (or 20) is disposed on an upper surface of the main mask-stage 132. A substrate 1 (shown in FIG. 3) is positioned in correspondence with a lower side of the main mask-stage 132, and is separated from the main mask-stage 132 by a predetermined distance.

The first and second assistant mask-stages 131 and 133 are respectively positioned at left and right sides with respect to the main mask-stage 132. That is, the first assistant mask-stage 131 is positioned between the main mask-stage 132 and the first mask loading/unloading part 110, and the second assistant mask-stage 133 is positioned between the main mask-stage 132 and the second mask loading/unloading part 120. As mentioned above, the mask (refer to a second mask 20 in FIG. 1 or a third mask 30 in FIG. 2) is always disposed on either of the first or the second assistant mask-stages 131 or 133, and accordingly the masks can always be available for a rapid exchange with the mask currently being used. Consequently, when a mask is changed, the ready mask can be promptly moved to the main mask-stage 132, and therefore the mask-change time can be significantly decreased.

The exposure system according to an embodiment of the present invention further includes a first shuttle [or linear mortion (LM) guider] 35 positioned between the main mask-stage 132 and the first assistant mask-stage 131, and a second shuttle (or LM guider) 36 positioned between the main mask-stage 132 and the second assistant mask-stage 133.

The substrate fixer 213 is positioned on a lower side of the main mask-stage 132 in correspondence therewith, and supports/fixes the substrate 1 during an exposure of the substrate 1.

The first and the second substrate loading/unloading parts 212 and 210 load a plurality of substrates, and may align a substrate 1.

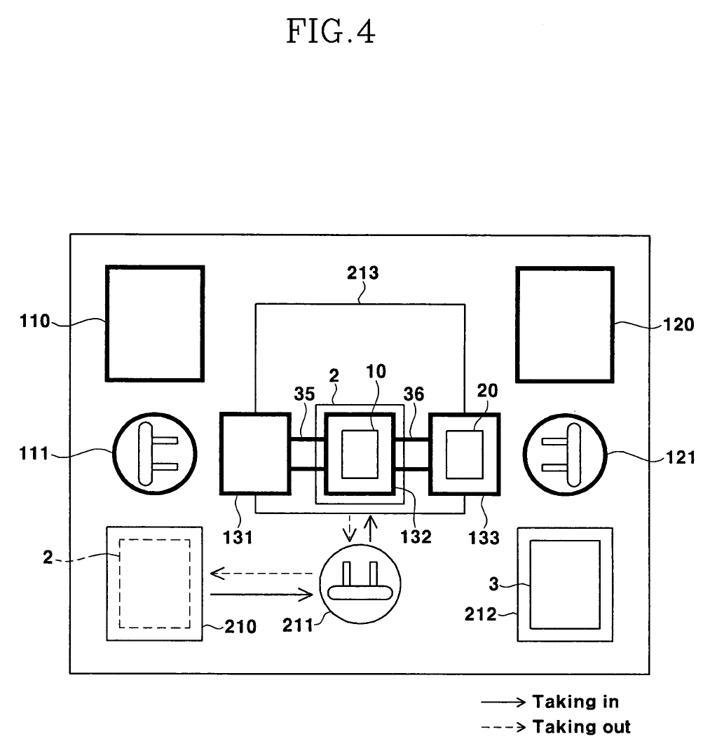

As shown in FIGS. 3 and 4, the substrate-transferer 211 transfers the substrate 1 from the first substrate loading/unloading part 212 onto the substrate fixer 213, and an exposure process is performed. At the same time, a substrate 2 is loaded onto the second substrate loading/unloading part 210.

The substrate-transferer 211 transfers the substrate 1 repeatedly performed the exposure process from the substrate fixer 213 onto the first substrate loading/unloading part 212. The substrate-transferer 211 transfers the substrate 2 from the second substrate loading/unloading part 210 onto the substrate fixer 213, and an exposure process is repeatedly performed.

A method for manufacturing a flat panel display according to an embodiment of the present invention will hereinafter be described in detail with reference to FIGS. 1 to 4.

First, as shown in FIG. 1, the first mask 10 is transferred from the first mask loading/unloading part 110 onto the main mask-stage 132 by the first mask-transferer 111.

The second mask 20 is transferred from the second mask loading/unloading part 120 onto the second assistant mask-stage 133 by the second mask-transferer 121.

Second, an exposure process is repeatedly performed using the first mask 10 on the main mask-stage 132.

The exposure process using the first mask 10 will hereinafter be described in more detail.

First, as shown in FIG. 3, the substrate 1 is transferred from the first substrate loading/unloading part 212 onto the substrate fixer 213 by the substrate-transferer 211. After the substrate 1 is aligned in correspondence with the first mask 10 by the substrate fixer 213, the substrate 1 is then fixed by the substrate fixer 213. At the same time, a new substrate 2 is loaded onto the second substrate loading/unloading part 210.

Second, the substrate 1 is exposed by the first mask 10 on the main mask-stage 132. Thereafter, the exposed substrate 1 is transferred from the substrate fixer 213 onto the first substrate loading/unloading part 212 by the substrate-transferer 211.

As shown in FIG. 4, the new substrate 2 is transferred from the second substrate loading/unloading part 210 onto the substrate fixer 213 by the substrate-transferer 211.

The above-described exposure process is repeatedly performed. During the exposure process, the first mask 10 may be used to expose about 100 to 1000 substrates. Thereafter, the first mask 10 may be changed as follows.

As shown in FIG. 1, the first mask 10 is transferred from the main stage 132 onto the first mask loading/unloading part 110 via the first assistant mask-stage 131 using the first shuttle 35 and the substrate-transferer 211.

Thereafter, as shown in FIG. 2, the second mask 20, disposed on the second assistant mask-stage 133, is transferred onto the main mask-stage 132. At this time, the shuttle (or LM guider) 36 positioned between the main mask-stage 132 and the second assistant mask-stage 133 is used for facilitating movement of the second mask onto the main mask-stage 132. Thereafter, the third mask 30 is transferred onto the first assistant mask-stage 131.

Thereafter, the above-mentioned exposure process is repeatedly performed by using second mask 20 on the main mask-stage 132.

As mentioned above, a mask may be changed while the exposure process is continuously performed.

Furthermore, according to the conventional scheme, when a mask is changed, the current mask is first completely transferred from the mask stage to the mask loading/unloading part by the mask-transferer, and then a new mask is transferred from the mask loading/unloading part to the mask stage. Accordingly, the mask-change time can be excessively long.

However, according to an embodiment of the present invention, multiple mask loading/unloading parts, mask-transferers, and assistant mask-stages are provided. Accordingly, as mentioned above, the mask-change time can be significantly decreased.

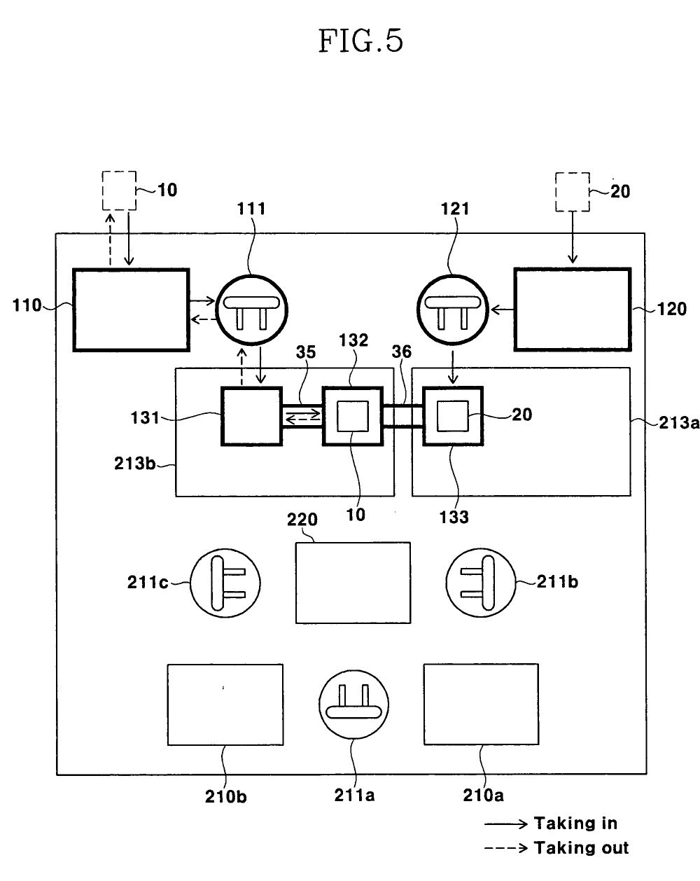

A system for manufacturing a flat panel display according to a second embodiment of the present invention will hereinafter be described in detail with reference to FIGS. 5 to 8.

FIGS. 5 to 8 are top plan views of an exposure system according to a second embodiment of the present invention, and show sequential operations in which a mask and a substrate are transferred. In the description, components identical to the aforementioned embodiment will be given the same reference symbols.

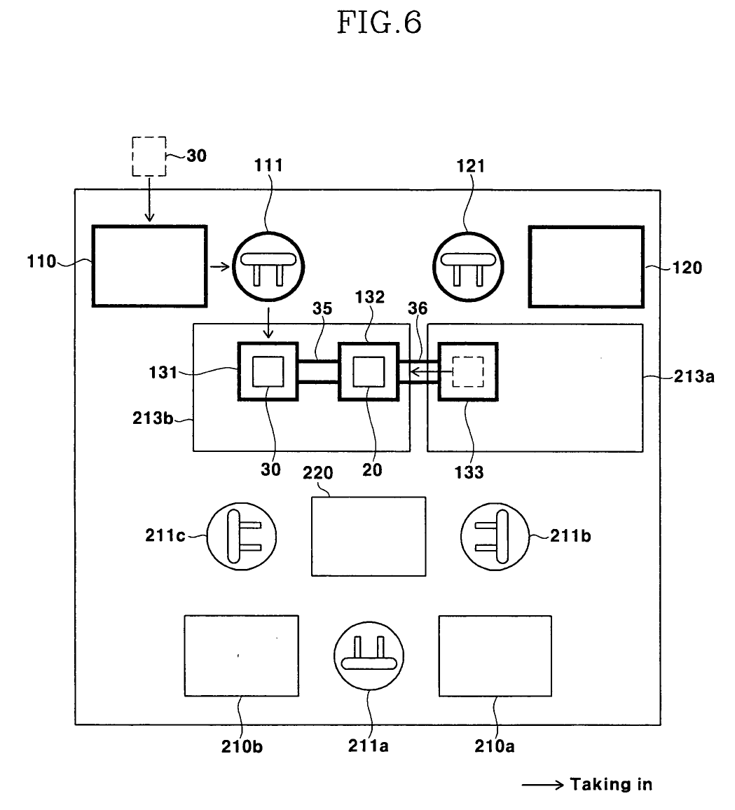

As shown in FIGS. 5 and 6, an exposure system according to a second embodiment of the present invention includes a first mask loading/unloading part 110, a first mask-transferer 111, a first assistant mask-stage 131, a main mask-stage 132, a second assistant mask-stage 133, a second mask-transferer 121, and a second mask loading/unloading part 120. Such devices 110, 111, 131, 132, 133, 121, and 120 for a mask are arranged in a generally “U”-shaped pattern.

The exposure system according to the second embodiment of the present invention further includes first and second substrate fixers 213a and 213b, first, second, and third substrate-transferers 211a, 211b, and 211c, a substrate aligning unit 220, a first substrate loading/unloading part 210a, and a second substrate loading/unloading part 210b. Such devices for handling the substrates are disposed apart from the above-mentioned mask-handling devices by a predetermined distance.

The first and second mask loading/unloading parts 110 and 120 are respectively loaded with a plurality of masks, and the first mask loading/unloading part 110 is positioned apart from the second mask loading/unloading part 120 by a predetermined distance.

The first mask-transferer 111 is configured to transfer a first mask 10 between the first mask loading/unloading part 110 and the first assistant mask-stage 131 (or directly onto the main mask-stage 132 if a mask is not already present thereupon).

The second mask-transferer 121 is configured to transfer a second mask 20 between the second mask loading/unloading part 120 and the second assistant mask-stage 133 (or directly onto the main mask-stage 132).

As mentioned above, since multiple mask-loaders and mask-transferers are provided, the time consumed for changing masks can be decreased.

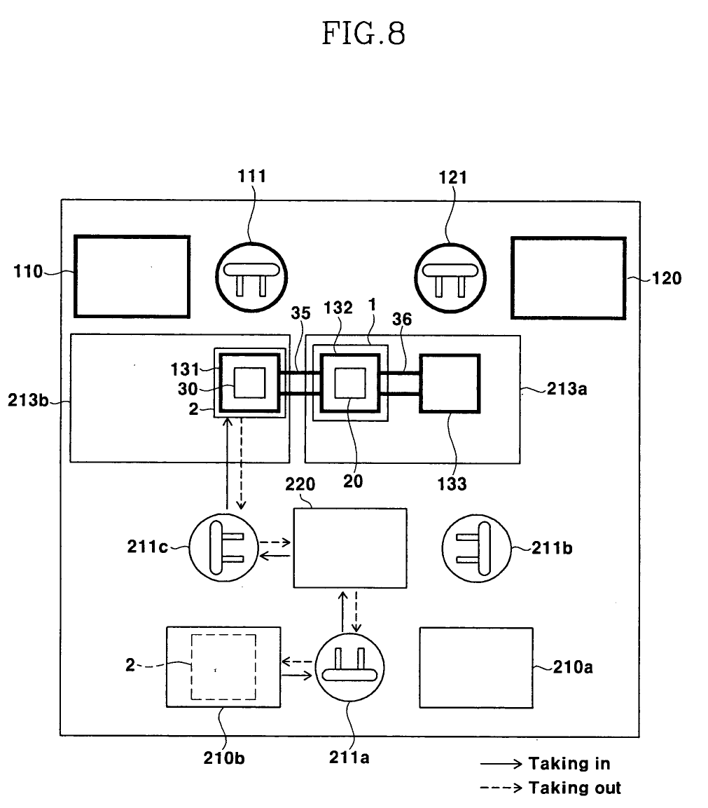

The mask 10 (or 20) is disposed on an upper surface of the main mask-stage 132. As shown in FIG. 8, a substrate 1 is positioned to be aligned with a lower side of the main mask-stage 132, and is separated from the main mask-stage 132 by a predetermined distance.

In the illustrated embodiment, the first and second assistant mask-stages 131 and 133 are respectively positioned at left and right sides with respect to the main mask-stage 132. That is, the first assistant mask-stage 131 is positioned between the main mask-stage 132 and the first mask loading/unloading part 110, and the second assistant mask-stage 133 is positioned between the main mask-stage 132 and the second mask loading/unloading part 120. As mentioned above, the mask (refer to a second mask 20 in FIG. 5 or a third mask 30 in FIG. 6) is always disposed on either of the first and the second assistant mask-stages 131 or 133, and accordingly the masks can always be available for a rapid exchange with the mask currently being used. Consequently, when a mask is changed, the ready mask can be promptly moved to the main mask-stage 132, and therefore the mask-change time can be significantly decreased.

The exposure system according to an embodiment of the present invention further includes a first shuttle [or Linear Motion (LM) guider] 35 positioned between the main mask-stage 132 and the first assistant mask-stage 131, and a second shuttle (or LM guider) 36 positioned between the main mask-stage 132 and the second assistant mask-stage 133.

The first and second substrate fixers 213a and 213b are respectively positioned adjacent to a lower side of the first and second assistant mask-stages 131 and 133, in correspondence therewith. Before an exposure process begins, either the first substrate fixer 213a or the second substrate fixer 213b is moved to a position corresponding with the main mask-stage 132.

The first substrate loading/unloading part 210a loads a plurality of substrates 1, and the substrate aligning unit 220 is surrounded by the first, second, and third substrate-transferers 211b, 211c, and 211a. The substrate aligning unit 220 aligns a substrate 1, before the substrate 1 is transferred onto the first or second substrate fixers 213a and 213b.

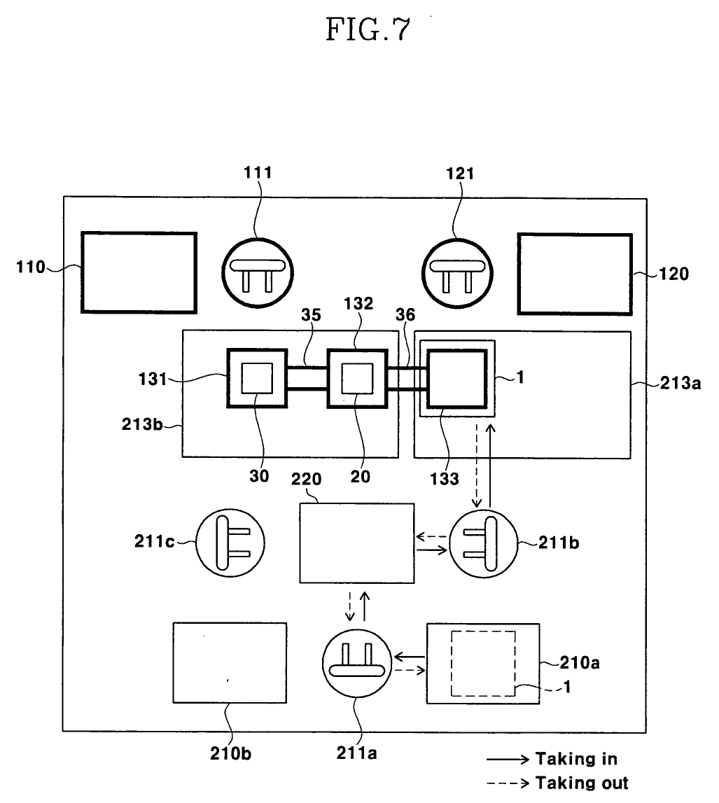

As shown in FIGS. 7 and 8, the first substrate-transferer 211a transfers a substrate 1 from the first substrate loading/unloading part 210b onto the substrate aligning unit 220. The second substrate-transferer 211b transfers the substrate 1 from the substrate aligning unit 220 onto the first substrate fixer 213a.

In the embodiment illustrated in FIGS. 5-8, multiple substrate fixers and substrate-transferers are provided, and the plurality of substrate fixers can be moved to a position corresponding with the main mask-stage 132.

A method for manufacturing a flat panel display according to an embodiment of the present invention will hereinafter be described in detail with reference to FIGS. 5 to 8.

First, as shown in FIG. 5, the first mask 10 is transferred from the first mask loading/unloading part 110 onto the main mask-stage 132 via the first assistant mask-stage 131 by the first mask-transferer 111 and the firs shuttle 35.

The second mask 20 is transferred from the second mask loading/unloading part 120 onto the second assistant mask-stage 133 by the second mask-transferer 121.

Second, an exposure process is repeatedly performed using the first mask 10 on the main mask-stage 132, while the second mask 20 is kept readily available on the second assistant mask-stage 133. During the exposure process, the first mask 10 may be used to expose about 100 to 1000 substrates. Thereafter, the first mask 10 may be changed as follows.

As shown in FIG. 5, the first mask 10 is transferred from the main stage 132 onto the first assistant mask-stage 131 using the first shuttle 35.

Thereafter, as shown in FIG. 6, the second mask 20, disposed on the second assistant mask-stage 133, is transferred onto the main mask-stage 132. The shuttle (or LM guider) 36 positioned between the main mask-stage 132 and the second assistant mask-stage 133 is used to transfer the second mask onto the main mask-stage 132.

Thereafter, the exposure process is repeatedly performed by using second mask 20 on the main mask-stage 132.

The exposure process will hereinafter be described in detail.

First, as shown in FIG. 7, a substrate 1 is transferred from the first substrate loading/unloading part 210a onto the substrate aligning unit 220 by the first substrate-transferer 211a. The substrate 1 is aligned by the substrate aligning unit 220, and is again transferred by the second substrate-transferer 211b from the substrate aligning unit 220 onto a first substrate fixer 213a.

Next, as shown in FIG. 8, the first substrate fixer 213a is moved such that the substrate 1 is positioned to the lower side of the main mask-stage 132.

After the substrate 1 is correctly aligned with the mask 20 on the main mask-stage 132, the substrate 1 is exposed by the second mask 20.

At this time, a new substrate 2 is transferred from the second substrate loading/unloading part 210b onto the substrate aligning unit 220 by the first substrate-transferer 211a. The substrate 1 is aligned by the substrate aligning unit 220, and is again transferred by the third substrate-transferer 211c from the substrate aligning unit 220 onto a second substrate fixer 213b.

Thereafter, as shown in FIG. 7, the exposed substrate is transferred from the first substrate fixer 213b onto the substrate aligning unit 220 by the second substrate-transferer 211b, and the aligned substrate is transferred from the substrate aligning unit 220 onto the first substrate loading/unloading part 201a by the first substrate-transferer 211a.

Such an exposure process may be repeatedly performed using the second mask 20.

Furthermore, according to the conventional scheme, when a mask is changed, the mask is first completely transferred from the mask stage to the mask loading/unloading part by the mask-transferer, and then a new mask is transferred from the mask loading/unloading part to the mask stage. Accordingly, the mask-change time is excessively consumed.

However, according to an embodiment of the present invention, multiple mask loading/unloading parts, mask-transferers, and the assistant mask-stages are provided. Accordingly, as mentioned above, the mask-change time can be significantly decreased.

As has been explained, systems and methods for manufacturing a flat panel display according to embodiments of the present invention may provide one or more of the following advantages.

According to the present invention, since a plurality of mask loading/unloading parts are provided, the time consumed for a mask-change can be decreased.

According to the present invention, since replacement masks are always available for a change on a plurality of assistant mask-stages, masks can be rapidly changed.

According to the present invention, since a shuttle (or LM guider) is provided, a mask can be easily moved from an assistant mask-stage onto the main mask-stage.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A system for manufacturing a flat panel display, comprising:
a first mask loading/unloading part for loading at least one mask;
a main mask-stage for receiving the mask;
a first mask-transferer for transferring the mask from the first mask loading/unloading part onto the main mask-stage;
a second mask loading/unloading part positioned apart from the first mask loading/unloading part by a predetermined distance; and
a second mask-transferer for transferring the mask from the second mask loading/unloading part onto the main mask-stage.

2. The system of claim 1, further comprising:
a first assistant mask-stage positioned between the main mask-stage and the first mask loading/unloading part; and
a second assistant mask-stage positioned between the main mask-stage and the second mask loading/unloading part.

3. The system of claim 2, wherein a shuttle or an LM guider is respectively positioned between the main mask-stage and the first assistant mask-stage, and between the main mask-stage and the second assistant mask-stage.

4. The system of claim 1, further comprising:
a substrate fixer positioned below the main mask-stage and apart therefrom by a predetermined distance;
a plurality of substrate loading/unloading parts for loading or unloading the substrate; and
a substrate-transferer for transferring a substrate from a selected substrate loading/unloading part of the substrate loading/unloading parts onto the substrate fixer or transferring the substrate from the substrate fixer onto the selected substrate loading/unloading part.

5. The system of claim 2, further comprising:
first and second substrate fixers respectively positioned below the first and second assistant mask-stages and apart therefrom by a predetermined distance;
first and second substrate loading/unloading parts for loading or unloading the substrate; and
first and second substrate-transferers for respectively transferring a substrate from the first and the second substrate loading/unloading parts onto the first and the second substrate fixers or respectively transferring the substrate from the first and the second substrate fixers onto the first and the second substrate loading/unloading parts.

6. The system of claim 5, wherein the first and second substrate fixers are horizontally moved.

7. A method for manufacturing a flat panel display, comprising:
transferring a first mask from a first mask loading/unloading part onto a main mask-stage by a first mask-transferer;
transferring a second mask from a second mask loading/unloading part onto a second assistant mask-stage by a second mask-transferer;
performing an exposure process for a predetermined time by the first mask on the main mask-stage;
transferring the first mask from the main mask-stage onto the first assistant mask-stage, and transferring a second mask from the second assistant mask-stage onto the main mask-stage, after completing the exposure process for predetermined time; and
performing an exposure process using the second mask on the main mask-stage for a predetermined time.

8. The method of claim 7, wherein the first mask and second mask have a same pattern.

9. The method of claim 7, further comprising:
transferring the first mask from the first assistant mask-stage onto the first mask loading/unloading part by the first mask-transferer;
transferring a third mask from the first mask loading/unloading part onto the first assistant mask-stage by the first mask-transferer;
transferring the second mask from the main mask-stage onto the second assistant mask-stage, and transferring the third mask from the first assistant mask-stage onto the main mask-stage, after completing the exposure process for the predetermined time by the second mask; and
performing an exposure process using the third mask on the main mask-stage for a predetermined time.

10. The method of claim 7, wherein the exposure process comprises:
transferring a substrate from a selected substrate loading/unloading part of the substrate loading/unloading parts onto a substrate fixer by a substrate-transferer;
exposing the substrate by the first mask on the main mask-stage; and
transferring the exposed substrate from the substrate fixer onto the selected substrate loading/unloading part.

11. The method of claim 7, wherein the exposure process comprises:
transferring a substrate from a first substrate loading/unloading part onto a first substrate fixer positioned to a lower side of any one of the fist assistant mask-stage and the second assistant mask-stage by a substrate-transferer;
moving the first substrate fixer such that the substrate is positioned to a lower side of the main mask-stage;
exposing the substrate by the first mask on the main mask-stage; and
transferring the exposed substrate from the first substrate fixer onto the first substrate loading/unloading part.
